(19) United States
(12) Patent Application Publication
(10) Pub. No.: US 2009/0100729 A1
(43) Pub. Date: Apr. 23, 2009

(54) Sticking dedication card

(76) Inventor: Refael Shmaia, Givati (IL)

Correspondence Address: Eckert Seamans Cherin & Mellott, LLC, U.S. Steel Tower, 600 Grant Street, 44th Floor, Pittsburgh, PA, 15219, US

(21) Appl. No.: 11/911,870

(22) PCT Filed: Apr. 23, 2006
(86) PCT No.: PCT/IL06/00496

§ 371 Date: Mar. 27, 2008

Related U.S. Application Data
(60) Provisional application No. 60/673,703, filed on Apr. 21, 2005.

(51) Int. Cl. G09F 3/10

(52) U.S. Cl. 40/638

(57) ABSTRACT

The present invention provides a blank sticking dedication card for a replaceable gift that comprises a self adhesive label having a base layer and a dedication card layer wherein between adhesive material is spread between the layers. The label is provided with a personalized area where a user can fill out a personal dedication. A separable portion is further associated with the self adhesive label so as to identify the gift when replacement is in order. The receiving user can adhere the dedication card on the original gift or on the replaced gift.

### FIELD OF THE INVENTION

The present invention relates to dedication cards. More particularly, the present invention relates to sticking dedication card for gifts, and especially books.

### BACKGROUND OF THE INVENTION

One of the most popular gestures in people relationships is dedicating gifts in almost any occasion in life. A dedication card almost always accompanies the gift. There are many gifts that are dedicated to a person and are intended to be kept for many years and some of them represent a personal allegiance or commitment. In many of those cases, the dedicating party would have wanted the gifts to carry the dedication card for as long as the gift is kept. An example for such a gift is books or booklets onto which the dedicating party writes a dedication since he should like the book to carry the dedication for as long as the book is kept and even more.

There is a problem in permanently attaching a dedication card or even write a dedication onto the gift itself since it is possible that the receiving party that received the gift already has this specific book or gift and would like the gift to be replaced. However, the receiving party would want to keep the dedication card and attach it onto the new replacement gift.

Cards that are not attached in any permanent or semi-permanent attachment to gifts tend to be lost over time and therefore there is a need to attach the dedication card onto the gift. This imposes a problem in all those cases where the gift is about to be replaced. In order to solve this problem, there is a need to introduce a dedication card that can be attached or connected to the gift after the gift is being replaced with another gift.

### SUMMARY OF THE INVENTION

It is an object of the present invention to provide a sticking dedication card for gifts that can be adhered on any dedicated gift, if desired, an original dedicated gift or a replaced gift.

It is another object of the present invention to provide a sticking dedication card for gifts provided preferably with a separable replacement extension.

It is therefore provided in accordance with a preferred embodiment of the present invention A blank sticking dedication card for a replaceable gift comprising:
a self adhesive label that comprises a base layer and a dedication card layer wherein between said base layer and said dedication layer, adhesive material is spread;
a personalized area provided on dedication card layer wherein said personalized area is adapted to allow a user to fill out a personal dedication;
a separable portion associated with said self adhesive label wherein said separable portion is adapted to be separated from said self adhesive label and to be filled with data facilitating a replacement of the gift.

Furthermore and in accordance with another preferred embodiment of the present invention, said separable portion is a portion of self adhesive label that is separable and is adapted to be torn of by a perforation line.

Furthermore and in accordance with another preferred embodiment of the present invention, said self adhesive layer is provided with an area dedicated for media publication.

Furthermore and in accordance with another preferred embodiment of the present invention, said self adhesive layer is provided with a pre-printed dedication area.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a blank sticking dedication card in accordance with a preferred embodiment of the present invention.

FIG. 2 illustrates layers of the sticking dedication card shown in FIG. 1.

FIG. 3 illustrates an example of the sticking dedication card shown in FIG. 1, filled by the selling party and dedicating user.

FIG. 4 illustrates a sticking dedication card in accordance with a preferred embodiment of the present invention, adhered on a book.

### DETAILED DESCRIPTION OF THE INVENTION AND FIGURES

The present invention provides a unique and new sticking dedication gift that can be connected to a replaceable gift by a person that receives the gift. The dedication card can be connected to the gift that was originally dedicated or can be connected to a replaced gift that was replaced by the receiving person in the store to another gift. It is important to notice that if the dedication card would have been permanently connected to the original gift by the person that gives the gift, the receiving person could have not been able to replace the gift. The same is applied if the dedication was performed by the dedicating person on the gift itself such as on an inner page or the binding of the book, as usually performed.

The present invention provides a self adhesive sticking card having a base layer and a dedicating card layer that are connected to each other by means of adhesive material. The dedication card layer can be peeled of the base layer at any time and be adhered on another surface preferably as a permanent connection. By this, a person that wishes to dedicate a gift to another and allow the other to replace the gift can write his own personal dedication on the card and dedicate it while leaving the card separated from the gift. The receiving person can adhere the card onto the gift he received or can replace the gift and adhere the dedication card as a reminder onto the replaced gift.

In accordance with another aspect of the present invention, the dedication card is provided with a separable portion that allows the shop or retailer from which the gift was bought from to identify the book so as to facilitate its replacement.

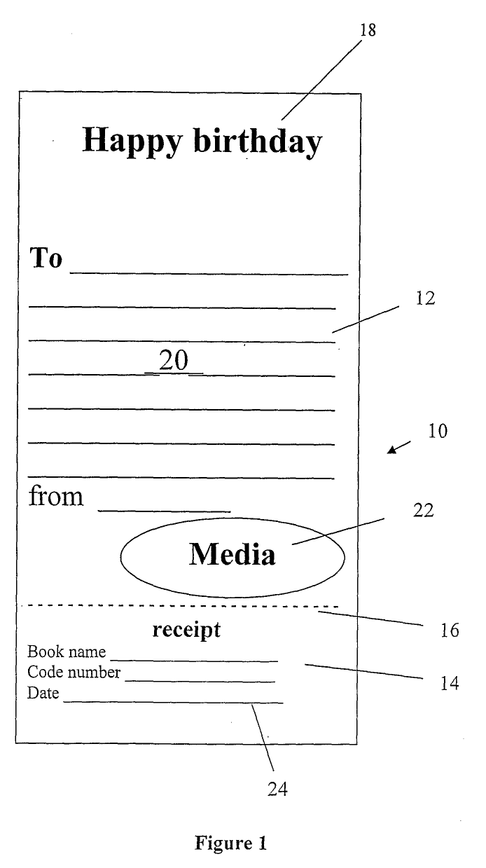

Reference is now made to FIG. 1 illustrating a blank sticking dedication card in accordance with a preferred embodiment of the present invention. A dedication card 10 comprises two main portions: a main body 12 and a separable portion 14. Both parts can be separated by a perforated line 16 adapted to allow separable portion 14 to be torn of main body 12. Any other separation mechanism can be applied onto card 10. Main body 12 comprises a general dedication area 18 that is usually pre-printed on card 10 providing a general statement indicating the occasion for giving the gift (the gift is not shown in the Figure) such as “happy birthday”; “happy anniversary”; “with love”; etc.

Main body 10 is further provided with a personalized area 20 in which the person dedicating the book can write his personal dedication remarks. An additional area 22 can be provided in order to allow media such as the book store, the gift shop, the book publication etc. to be published.

Separable portion 14 is provided with a area 24 that allows the store to enter information such as the gift's code, barcode, date of purchase, due date for replacement, receipt, etc. for facilitating the gift to be replaced. Separable portion 14 can be associated with main body 12 in different ways that by no way limit the scope of the present invention. Area 24 can be optionally provided with instructions on how to use the product instead of replacement information or in addition to the replacement information.

It should be noted that the two portions of the dedication card can be organized in any manner so that the portions will be side by side, dedication card on top and separable portion below (as in the figures), or upside sown.

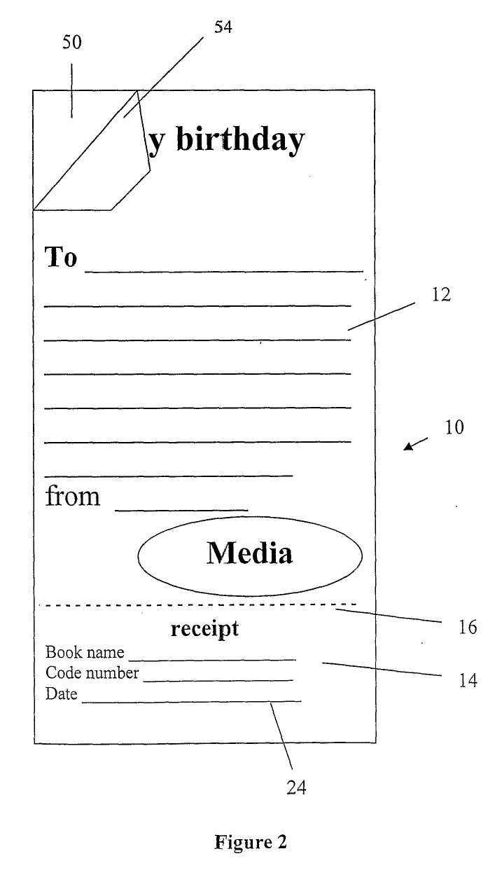

Reference is now made to FIG. 2 illustrating layers of the sticking dedication card shown in FIG. 1. As mentioned herein before, it is preferable that the card will be made of self adhesive materials that are known in the art of self adhesive labels. Main body 12 is comprised of a base layer 50 and a dedication card layer 52. Between the layers and adhered to dedication card layer 52, adhering material 54 is provided. When dedication card 52 is peeled of base layer 50, the adhering material is left on the dedication card so as to allow its adhering onto another surface.

It is preferable to provide an adhesive material that can be adhered and removed more than once so that if the person dedicating the gift wishes to adhere the dedication card onto a book, as an example, and the person that received the gift is replacing the gift, the dedication card will be easily removed of the book and re-adhered on another one. It is important that the characteristics of the adhering materials will be such that there will not no damage inflicted on the gift from which the dedication card was removed.

The use of the card is as follows: the user that wishes to dedicate a gift such as a book, buys the gift and receives the sticking dedication card. The user fills the card as will be shown herein after and dedicates the gift. The person that receives the gift can keep it, if he so desires, and adhere the sticking dedication card onto the gift so as to cherish the dedication of the person that gave his the gift. However, if the receiver has already the item that he received or wishes to replace it from another reason and still wishes to cherish the gift, he can turn to the shop in which the gift was bought and replace it with using the receipt he has on the separable portion of the dedication card. The shop replaces the gift according to the receipt and the person can adhere the sticking dedication card on a gift that he replaced so as to connect the gift to the dedicating person.

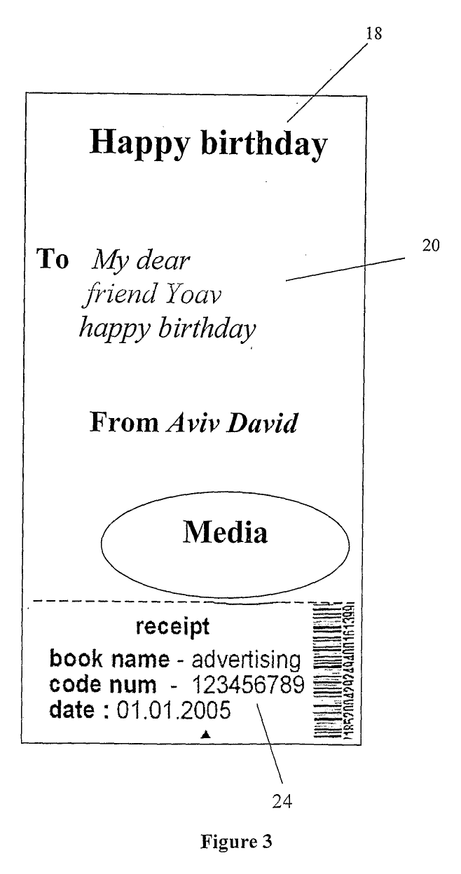

Reference is now made to FIG. 3 illustrating an example of the sticking dedication card shown in FIG. 1, filled by the selling party and dedicating user. Personalized area 20 is filled by the user that dedicates the gift. Filling area 24 is filled by the shop in which the book was bought. Optional data that can be filled is the gift name, the code and the date it was bought or the due date for replacement. A barcode as shown can be also provided in order to facilitate the replacement procedure.

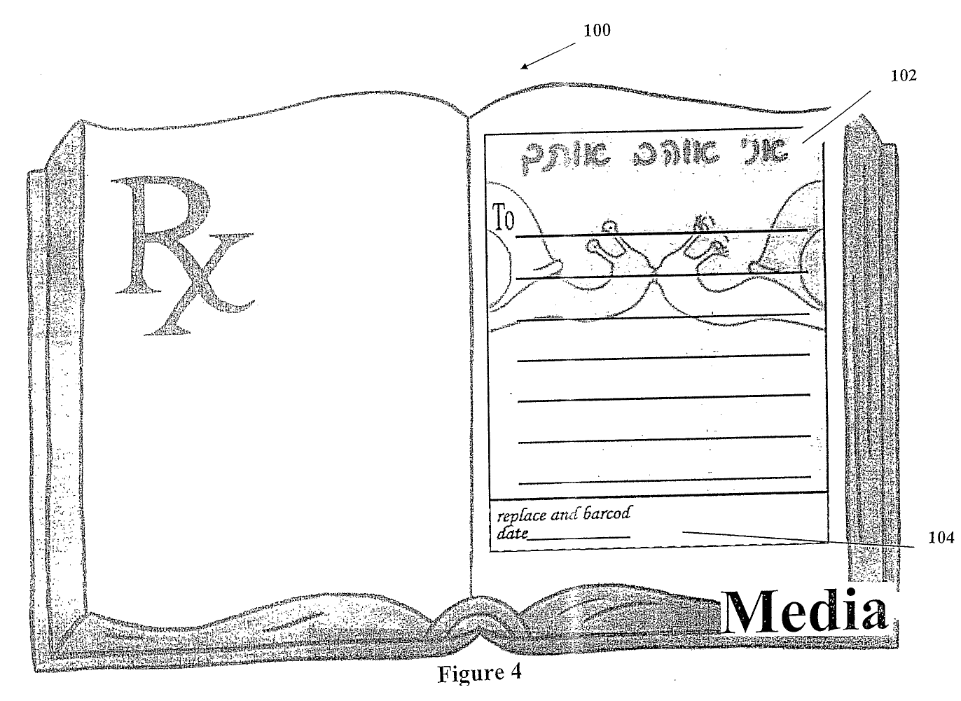

Reference is now made to FIG. 4 illustrating a sticking dedication card in accordance with a preferred embodiment of the present invention, adhered on a book. If the receiver of a book 100, which is the gift that is received, decides to keep the book, he adheres card 102 to book 100 in a way shown in FIG. 4. In case the receiver decides to replace the book, he can do it with the replacement separable portion 104 where the book can be replaced to another one. The receiver can then adhere the dedication card to the new book.

It should be noted that the design of the separable portion can be such that it can be used as a bookmark for books, in case the gift is a book.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A blank sticking dedication card for a replaceable gift comprising:
a self adhesive label that comprises a base layer and a dedication card layer wherein between said base layer and said dedication layer, adhesive material is spread;
a personalized area provided on dedication card layer wherein said personalized area is adapted to allow a user to fill out a personal dedication;
a separable portion associated with said self adhesive label wherein said separable portion is adapted to be separated from said self adhesive label and to be filled with data facilitating a replacement of the gift.

2. The blank as claimed in claim 1, wherein said separable portion is a portion of self adhesive label that is separable and is adapted to be torn of by a perforation line.

3. The blank as claimed in claim 1, wherein said self adhesive layer is provided with an area dedicated for media publication.

4. The blank as claimed in claim 1, wherein said self adhesive layer is provided with a pre-printed dedication area.

5. The blank as claimed in claim 1, wherein said adhesive material can be used multiple of times.

6. A blank sticking dedication card for a replaceable gift substantially as described in the above specification, attached Figures and appending claims.
